(19) United States
(12) Patent Application Publication
(10) Pub. No.: US 2016/0260149 A1
(43) Pub. Date: Sep. 8, 2016

(54) Biometric Case Design

(71) Applicant: Google Inc., Mountain View, CA (US)

(72) Inventors: Kari Clark, Mountain View, CA (US); Nick Jonas, New York City, NY (US); TQ Queenan, Brooklyn, NY (US); Jordan Crane, Hudson, NY (US)

(21) Appl. No.: 14/636,554

(22) Filed: Mar. 3, 2015

(51) Int. Cl. G06Q 30/06; G06F 3/12; G06K 15/02

(52) U.S. Cl. CPC G06Q 30/0621; G06K 15/021; G06F 3/1293

(57) ABSTRACT

Systems and techniques are provided for biometric case design. According to an embodiment of the disclosed subject matter, a biometric input may be received at a biometric input device of a computing device. The biometric input may be generated through user interaction with the biometric input device. Biometric data may be generated from the biometric input. A biometric design may be generated based on the biometric data. The biometric design may be printed on an accessory for an electronic device with a printer co-located with the computing device.

### BACKGROUND

Electronic devices may have a number of accessories available to protect or customize the electronic device. For example, cases may be purchased for smartphones. Different cases may provide varying level of protection for a smartphone, and may also include varying designs and color schemes. A user may select a case for their smartphone based not only on the level of protection, but on their preference for certain designs and colors. Similarly, watches, including, for example, smart watches, may have replaceable watch bands. A user may select a watch band for their smart watch based on comfort and design, for example, selecting a watch band with different colors than a band that may have come with the smart watch originally. A user may be limited in their selection of designs for electronic device accessories to those designs created by manufacturers, or to designs that the user creates themselves, for example, using photographs.

### BRIEF SUMMARY

According to an embodiment of the disclosed subject matter, a biometric input may be received at a biometric input device of a computing device. The biometric input may be generated through user interaction with the biometric input device. Biometric data may be generated from the biometric input. A biometric design may be generated based on the biometric data. The biometric design may be printed on an accessory for an electronic device with a printer co-located with the computing device.

The biometric data may include a representation of the biometric input and an aspect of the biometric input. The biometric design may be based on the representation of the biometric input or an aspect of the biometric input. The biometric input device may be a microphone, a camera, a fingerprint scanner, a heart-rate monitor, or a thermometer. The biometric input may include speech or sounds from the user, a scan of a fingerprint of the user, a heart-rate of the user, or a temperature of the user.

An aspect of the biometric input comprises a frequency, speed, pattern or volume of a sound wave, or a strength, beat, or pattern of a heart-rate. The accessory may be a smartphone case, a watch band, or a laptop case. The visual basis for the biometric design is automatically selected. The aspect of the biometric input on which the biometric design is based may be automatically selected.

A receiving design input may be received. The biometric design may be adjusted based on the design input. The design input may include a color change or a change to a visual basis for the biometric design. A display may display a rendering of the accessory with the biometric design.

A live wallpaper may be generated based on the biometric design. The live wallpaper may be sent to the electronic device. The live wallpaper may include an animation visually based on the biometric design. The animation of the live wallpaper may be based on input to the electronic device.

According to an embodiment of the disclosed subject matter, a means for receiving biometric input at a biometric input device of a computing device, wherein the biometric input is generated through user interaction with the biometric input device, a means for generating biometric data from the biometric input, a means for generating a biometric design based on the biometric data, a means for printing the biometric design on an accessory for an electronic device with a printer co-located with the computing device, a means for receiving design input, a means for adjusting the biometric design based on the design input, a means for generating a live wallpaper based on the biometric design, and a means for sending the live wallpaper to the electronic device, are included.

Systems and techniques disclosed herein may allow for biometric case design. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for biometric case design according to an implementation of the disclosed subject matter.

FIG. 2 shows an example arrangement for biometric case design according to an implementation of the disclosed subject matter.

FIG. 3 shows an example screenshot for biometric case design according to an implementation of the disclosed subject matter.

FIG. 4A shows an example biometric case design according to an implementation of the disclosed subject matter.

FIG. 4B shows an example biometric case design according to an implementation of the disclosed subject matter.

FIG. 4C shows an example biometric case design according to an implementation of the disclosed subject matter.

FIG. 5 shows an example of a process for biometric case design according to an implementation of the disclosed subject matter.

FIG. 6A shows an example live wallpaper according to an implementation of the disclosed subject matter.

FIG. 6B shows an example live wallpaper according to an implementation of the disclosed subject matter.

FIG. 6C shows an example live wallpaper according to an implementation of the disclosed subject matter.

FIG. 7 shows an example of a process for live wallpaper for a biometric case design according to an implementation of the disclosed subject matter.

FIG. 8 shows a computer according to an embodiment of the disclosed subject matter.

FIG. 9 shows a network configuration according to an embodiment of the disclosed subject matter.

### DETAILED DESCRIPTION

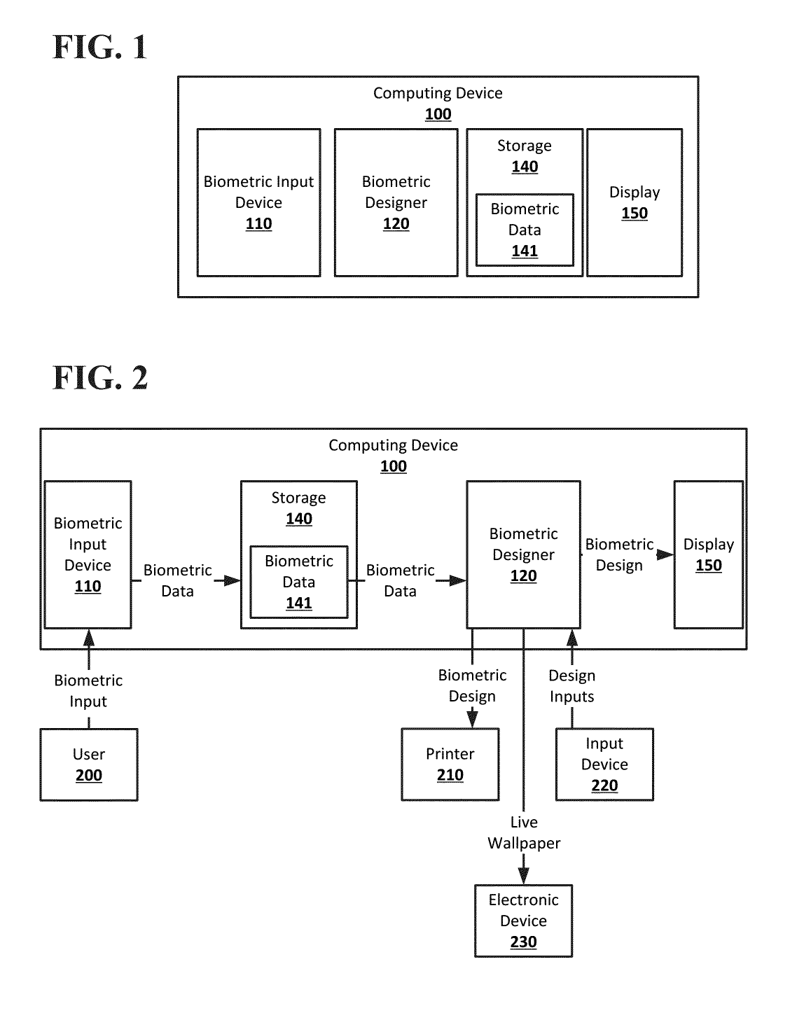

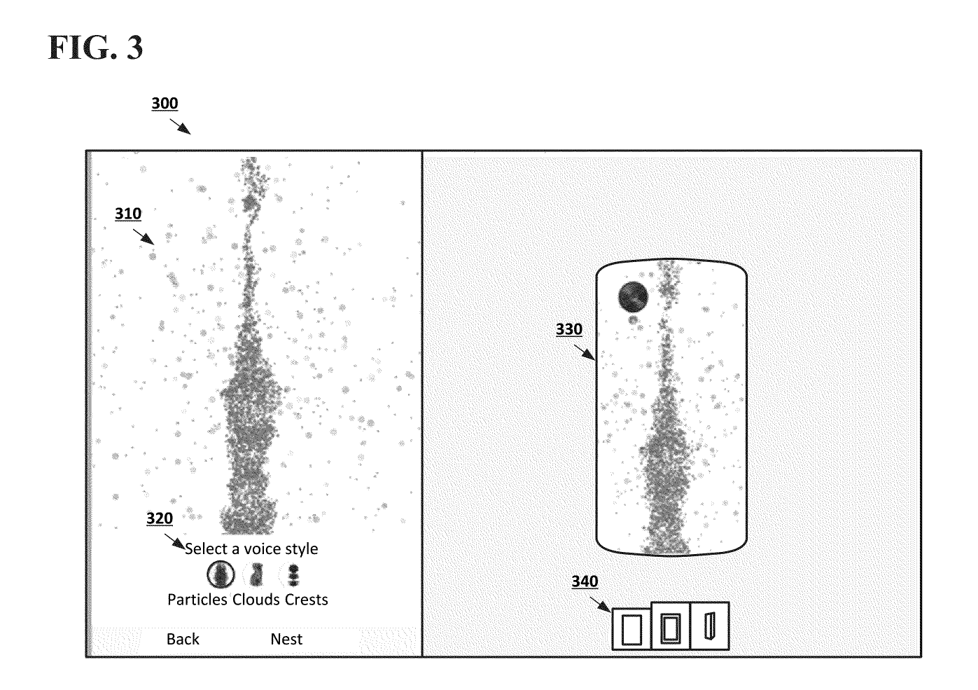

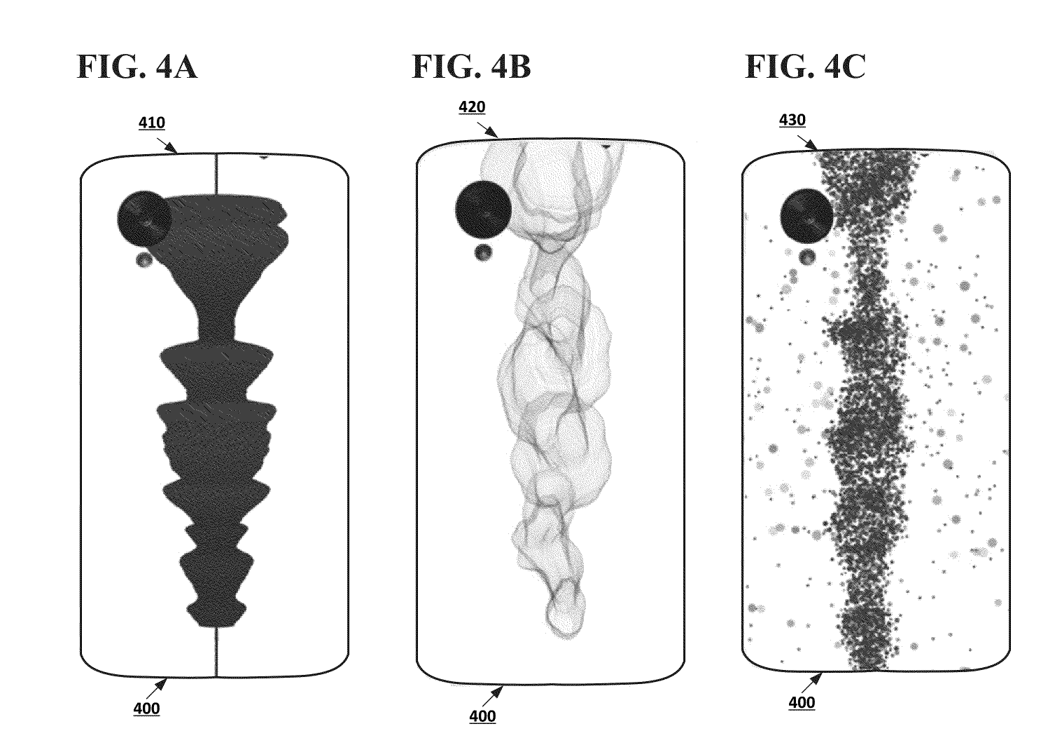

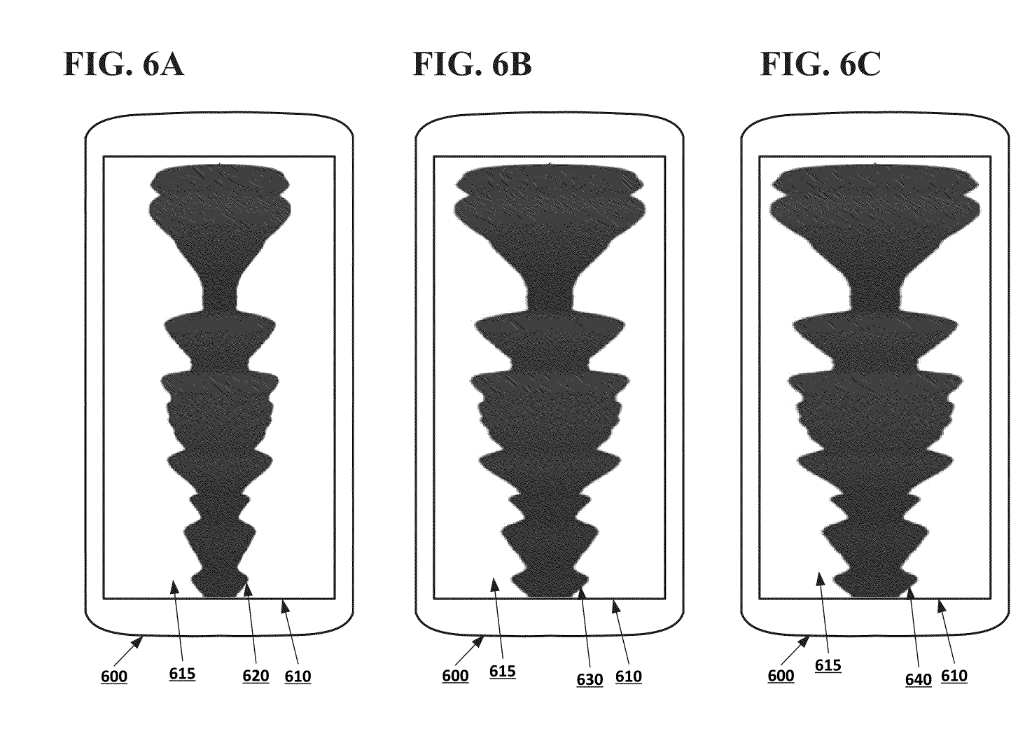

According to embodiments disclosed herein, referring to FIG. 2 and FIG. 4, biometric case design may allow for the creation of an accessory 400 for an electronic device 230 that includes a design based on biometrics of a user 200 of the electronic device 230. Referring to FIG. 1, a computing device 100, such as, for example, a smartphone, tablet, laptop, or desktop, may include a biometric input device 110. The biometric input device 110 may be, for example, a microphone, camera, heart-rate monitor, fingerprint scanner, or any other suitable device for receiving biometrics from a user 200. A user 200 may input a biometric into the biometric input device 110. For example, a user 200 may speak a phrase into a microphone. The biometric input may be stored as biometric data 141, which may include any data relevant to the biometric input. For example, the biometric data 141 may include a sound wave recorded from the microphone, and may also include data based on analysis of the sound wave, such as frequency, speed, and volume. Referring to FIG. 3, the biometric data 141 may be used to create a biometric design 310 for an accessory 400 for an electronic device 230, such as a case for a smartphone. The user 200 may be able to adjust certain aspects of the biometric design 310. The biometric design 310 may then be printed onto the accessory 400 by a printer 210 attached to the computing device 100. Referring to FIG. 6, the computing device 100 may also generate a live wallpaper 615 based on the biometric design 310. The live wallpaper 615 may be sent to the electronic device 230 to be displayed on a screen of the electronic device 230, allowing the design displayed on the screen to complement the biometric design 310 on the accessory 400 for the electronic device 230.

A computing device 100, such as, for example, a smartphone, tablet, laptop, or desktop, may include a biometric input device 110. The biometric input device 110 may be, for example, a microphone, camera, heart-rate monitor, fingerprint scanner, or any other suitable device for receiving biometrics from a user 200. The biometric input device 110 may be built into the computing device 100, or may be an accessory 400 attached to the computing device 100. For example, a laptop computer may include a microphone, or may have a microphone attached using any suitable wired or wireless connection. The computing device 100 may be, for example, part of a display or kiosk within a store.

The computing device 100 may receive biometric input from a user 200 through the biometric input device 110. For example, the user 200 may speak a particular phrase into a microphone attached to the computing device 100, wear a heart rate monitor, or place their finger on a fingerprint scanner. The biometric input from the user 200 may be stored by the computing device 100 as biometric data 141. The biometric data 141 may be in any suitable format, and include any suitable additional analyses of the biometric input. For example, a phrase spoken into a microphone by a user 200 may be stored in any suitable format audio format that includes the sound wave generated by the user 200, which may be stored with analyses of the frequency, speed, volume, patterns or any other suitable aspect of the sound wave. A hear-rate received from a heart-rate monitor may be stored along with an analyses of the beat, pattern, and strength of the heart-beat.

The biometric data 141 stored based on the biometric input may be used as the basis for a biometric design 310. For example, the biometric data 141 including a sound wave may be used to generate a biometric design 310 that is a visual representation of the sound wave, or of data associated with the sound wave. For example, the sound wave may be depicted as waveform, using a particle scatter plot, or using a cloud representation. The biometric design 310 may be generated based on any suitable aspects of the biometric data 141, including, for example, the recording of the biometric input and the associated data from analyses of the biometric input. The biometric design 310 may take the form of any suitable visual representation or abstraction of the biometric data 141, and may or may not directly depict the biometric data 141. For example, the biometric design 310 may depict a sound wave from biometric audio input using a recognizable sound wave depiction, or may be an abstract depiction based on the sound wave and other biometric data 141 associated with the sound wave. The abstract depiction may not necessarily be recognizable as having been generated based on a sound wave.

The user 200 may be able to change or edit certain aspects of the biometric design 310. For example, the user 200 may be presented with the biometric design 310 generated from the biometric data 141 input by the user 200. Using an input device 220 such as a mouse, keyboard, or touchscreen connected to the computing device 100, the user 200 may manipulate the biometric design 310. The user 200 may, for example, be presented with certain visual depiction options for the biometric design 310. For example, for a sound wave from biometric audio input, the user 200 may be able to select whether the sound wave is visually depicted using waveform, particle scatterplot, or cloud representations. The user 200 may be able to select and change the color palette used by the biometric design 310, and zoom in or zoom out on the biometric design 310. The computing device 100 may present the user 200 with a visual depiction of how the biometric design 310 may look on the accessory 400, for example, smartphone case, the user 200 may use when modifying the design to their preference. The computing device 100 may present different views of the accessory 400, so that the user 200 may see what the biometric design 310 may look like on the accessory 400 from various angles.

The biometric design 310 may be printed onto an accessory 400. A printer 210 suitable for printing on electronic device 230 accessories 400, such as smartphone cases, watch bands, and laptop cases, may be connected to the computing device 100 in any suitable manner. The printer 210 may be co-located with the computing device 100, for example, in the same room, or as part of the same kiosk or display. When the user 200 is satisfied with the biometric design 310, they may select to have the biometric design 310 printed onto the accessory 400. The computing device 100 may send the biometric design 310 to the printer 210, which may then print the biometric design 310 onto the accessory 400. The user 200 may then be able to take and begin using the printed accessory 400.

The computing device 100 may also use the biometric data 141 to generate a live wallpaper 615 for the electronic device 230 of the user 200. The biometric design 310 that is printed on the accessory 400 may be used as the basis for the live wallpaper 615. For example, the biometric design 310 may be a waveform from a sound wave from biometric audio input. The computing device 100 may generate a live wallpaper 615 that includes the waveform from the sound wave. The live wallpaper 615 may be animated, and the animation may be responsive to the environment of the electronic device 230 on which the live wallpaper 615 is in use, on biometric data 141 associated with the biometric design 310 from which the live wallpaper 615 was generated, or in any other suitable manner. For example, the live wallpaper 615 may be generated so that, when in use on an electronic device 230, the waveform on the live wallpaper 615 may act as sound meter for the environment surrounding the electronic device 230. For example, the microphone on a smartphone may be used to measure the level of noise in the smartphone's environment, and the waveform on the live wallpaper 615 may depict an increase or decrease in the amplitude of the waveform to match the changing noise level. A live wallpaper 615 generated from biometric heart-rate input may be animated to match the heart beat from the hear-rate input, or may be animated to match the current heart-beat of the user 200 as measured by their electronic device 230 or an accessory 400 connected thereto.

The live wallpaper 615 generated by the computing device 100 may be sent to the electronic device 230 of the user 200 in any suitable manner. For example, a live wallpaper 615 may be sent to a smartphone using a Bluetooth, WiFi, or NFC file transfer, or via an email or SMS to the smartphone. The user 200 may set the live wallpaper 615 as the wallpaper of their electronic device 230. This may result in the electronic device 230 having a live wallpaper 615 with a visual depiction of a biometric that matches the biometric design 310 on an accessory 400 for an electronic device 230. For example, a user 200 may have smartphone with a case that includes a biometric design 310 generated from the voice of the user 200 and a live wallpaper 615 with a similar biometric design 310 that is responsive to the noise level in the environment.

The biometric data 141 may be erased after being used to generate the biometric design 310. For example, the user 200 may be presented with the option of storing the biometric data 141 for future use, or erasing the biometric data 141 from the computing device 100.

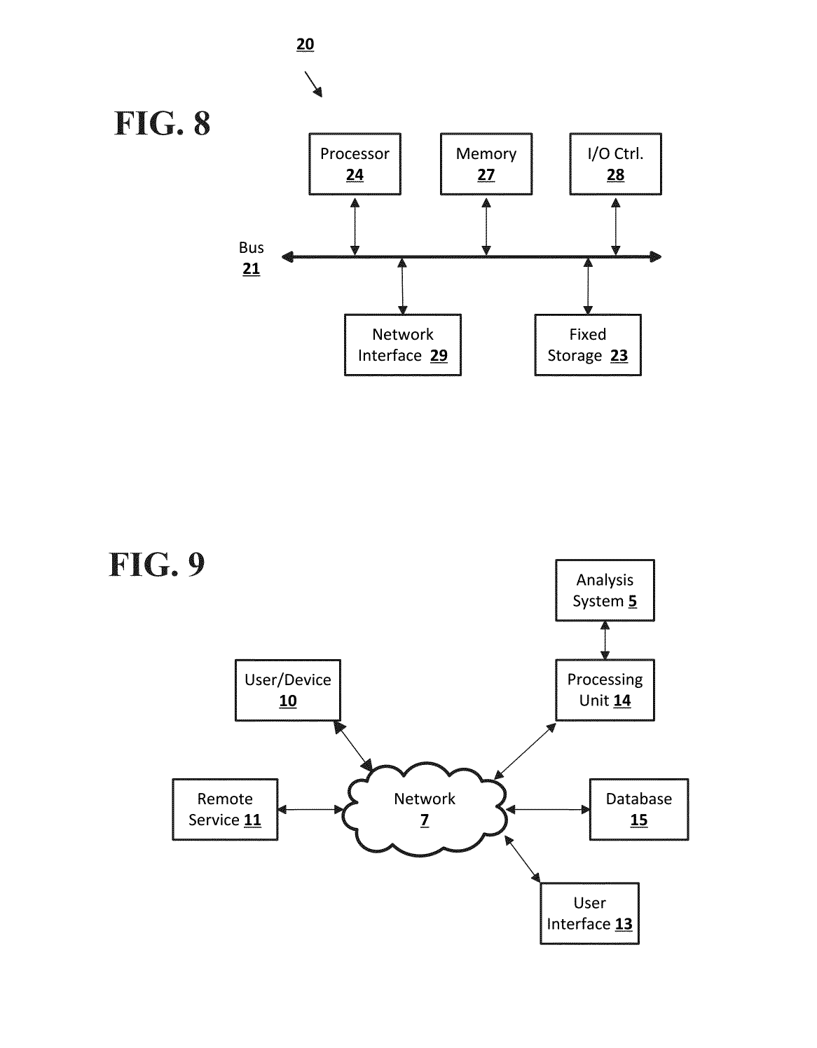

FIG. 1 shows an example system suitable for biometric case design according to an implementation of the disclosed subject matter. A computing device 100 may include a biometric input device 110, a biometric designer 120, a storage 140, and a display 150. The computing device 100 may be any suitable device, such as, for example, a computer 20 as described in FIG. 8, for implementing the biometric input device 110, the biometric designer 120, the renderer 130, and the storage 140. The computing device 100 may be a single computing device, or may include multiple connected computing devices, and may be, for example, a smartphone, tablet, laptop, desktop, or other computing device in any form factor that may be used in a retail environment such as a store. The display 150 may be a part of the computing device 100, or may be separate from the computing device 100. For example, the display 150 may be a touchscreen on a smartphone, a monitor connected to a laptop, or a television receiving streaming video from the computing device 100. The biometric input device 110 may be any combination of hardware and software for receiving and capturing biometric input from a user 200 and generating biometric data 141, and may be built into or connected to the computing device 100. For example, the biometric input device 110 may be a microphone, camera, fingerprint scanner, heart-rate monitor, thermometer, or any other suitable hardware for capturing and analyzing biometric input. The biometric designer 120 may be any suitable combination of hardware and software, for example, an application, on the computing device 100 for generating biometric designs from the biometric data 141 and editing or otherwise manipulating the biometric designs. The storage 140 may store the biometric data 141 in any suitable manner.

The computing device 100 may be any suitable computing device for receiving biometric input, generating the biometric data 141, generating the biometric design and sending the biometric design to be printed onto an accessory 400 for an electronic device 230. For example, the computing device 100 may be a smartphone, tablet, laptop, or desktop that may be part of a display or kiosk in a retail environment. The computing device 100 may include the biometric input device 110, which may be, for example, a microphone, camera, fingerprint scanner, heart-rate monitor, thermometer, or other device capable of capturing biometric input, and may be built into or otherwise connected, wired or wirelessly, to the computing device 100. The biometric input device 110 may be, for example, a built-in microphone of a tablet, or a Bluetooth microphone connected to a desktop computer. The hardware of the biometric input device 110 may be available for use by a user 200 within a retail environment. For example, a microphone may be placed within a store so that a customer in the store may be able to speak into it. The biometric input device 110 may receive biometric input, for example, in the form of sound waves, heart-beats, or fingerprint patterns, and store the biometric input in any suitable format as the biometric data 141 in the storage 140. For example, biometric audio input may be stored as a sound wave using any suitable audio format. The biometric input device 110 may also analyze the biometric input to generate additional biometric data 141. For example, sound waves may be analyzed for frequency, speed, and volume, or a heart-rate may be analyzed for beat, pattern, and strength. This additional biometric data 141 may be stored along with the biometric input as part of the biometric data 141.

The computing device 100 may include the display 150, which may be a hardware display 150 in combination with any suitable software to allow the display 150 to display images generated by the computing device 100.

The computing device 100 may include the biometric designer 120. The biometric designer 120 may be any suitable combination of hardware and software on the computing device 100 for generating biometric designs from the biometric data 141 and editing or otherwise manipulating the biometric designs. For example, the biometric designer 120 may be an application running on the computing device 100. The biometric designer 120 may be able to receive the biometric data 141 and generate a biometric design based on the biometric data 141. The biometric design may be any suitable design based on any aspects of the biometric data 141. For example, the biometric design may be a particle scatterplot of a sound wave form the biometric data 141, or may be a warping of a design with a regular or repeating pattern based on aspects of the biometric data 141 that were generated by analyzing the biometric input, such as the pattern of a heart-beat determined by analyzing biometric heart-rate input. The generation of the biometric design may be automatic and based on pre-chosen aspects of the biometric data 141, or the user 200 may be allowed to select some or all of the aspects used to generate the biometric design. The visual basis of the biometric design may also be selected automatically or by the user 200. For example, the user 200 may be able to select whether a sound wave may be represented as a waveform, particle scatter plot, or with a cloud representation.

The user 200 may be able to edit and manipulate the biometric design, for example, changing the colors used by the biometric design and zooming in or out on the biometric design. The biometric designer 120 may allow the user 200 to view, on the display 150, a depiction of what the biometric design may look like on the accessory 400 on which it will be printed. For example, the display 150 may show a depiction of a waveform on a smartphone case. The user 200 may be able to select different accessories 400 using the biometric designer 120, and may be able to view the selected accessory 400 and biometric design from different angles and at different levels of zoom.

The biometric designer 120 may also be able to generate a live wallpaper 615. The live wallpaper 615 may be generated based on the biometric design, so that the live wallpaper 615 may complement the biometric design printed on the accessory 400. For example, the biometric design may be a waveform taken from a sound wave, and the live wallpaper 615 may be the same waveform, or a different waveform taken from the same sound wave. The live wallpaper 615 may be sized and shaped appropriately for the electronic device 230 on which it will be installed. For example, a live wallpaper 615 for a smart watch may be smaller and circular, while a live wallpaper 615 for a smartphone may be larger and rectangular. The user 200 may be able to select properties of the live wallpaper 615, such as, for example, the manner in which the live wallpaper 615 is animated. For example, the user 200 may use the biometric designer 120 to indicate the live wallpaper 615 should be animated based on the noise level around the electronic device 230. The user 200 may also be able to edit and manipulate the live wallpaper 615, for example, selecting colors and zooming in or out.

The biometric designer 120 may be able to send the biometric design to a printer 210, and send the live wallpaper 615 to the electronic device 230. For example, when the user 200 is satisfied with the biometric design and live wallpaper 615, the user 200 may select to have the biometric design printed the accessory 400 for which it was designed. The biometric designer 120 may send the biometric design to any suitable printer 210, which may then print the biometric design on the appropriate accessory 400. The biometric designer 120 may also send, using any suitable wired or wireless connection, the live wallpaper 615 to the electronic device 230.

FIG. 2 shows an example arrangement for biometric case design according to an implementation of the disclosed subject matter. The biometric input device 110 of the computing device 100 may receive biometric input from a user 200. The user 200 may be, for example, a customer in a store. For example, the user 200 may speak into a microphone connected to the computing device 100, may put on a heart-rate monitor connected to the computing device 100, or may place their finger on a fingerprint scanner connected to the computing device 100.

The biometric input device 110 may receive and capture the biometric input from the user 200. For example, the biometric input device 110 may record the sound wave generated by the user 200 speaking into a microphone, or may capture the heart-rate of the user 200 wearing a heart rate monitor. The biometric input device 110 may analyze the received biometric input to determine other aspects of the biometric input, for example, determining the frequency, speed, and volume of a recorded sound wave, or the beat, pattern, and strength of a captured heart-rate. The biometric input and aspects of the biometric input determined through analysis may be the biometric data 141.

The biometric input device 110 may store the biometric data 141 in the storage 140. The biometric data 141 may be stored in any suitable format, and may include a stored representation of the biometric input, such as, for example, a sound wave stored in any suitable audio format, along with any aspects of the biometric input that were determined through analysis by the biometric input device 110.

The biometric designer 120 may receive the biometric data 141 from the storage 140. The biometric designer 120 may generate a biometric design which may be displayed on the display 150. The biometric design may be visual depiction of the biometric data 141, and may be based on any suitable aspects of the biometric data 141. The user 200, or another party, may use the input device 220 to edit or manipulate the biometric design. The input device 220 may be, for example, a keyboard, mouse, touchpad, touchscreen, drawing tablet, or any other suitable input device. The biometric designer 120 may receive design inputs from the input device 220, and may adjust the biometric design according to the design inputs. For example, the design inputs may cause the biometric designer 120 to change the colors of the biometric design. The biometric designer 120 may also generate a live wallpaper 615 based on the biometric data 141. The live wallpaper 615 may be generated to complement the biometric design, and may be edited or manipulated based on design inputs received from the input device 220.

The biometric design may be sent to a printer 210. The printer 210 may be any suitable printer 210 for printing on accessories 400 for electronic devices, such as smartphone cases, watch bands, and laptop cases. The printer 210 may be co-located with the computing device 100. For example, the printer 210 may be in the same room, as part of the same display 150 or kiosk, as the computing device 100. The user 200 may indicate to the biometric designer 120 that the biometric design should be printed. The biometric designer 120 may then send the biometric design to the printer 210, and the printer 210 may print the biometric design on an accessory 400 that was selected by the user 200. The biometric designer 120 may also send the live wallpaper 615 to the electronic device 230. The electronic device 230 may be, for example, a smartphone, tablet, smart watch, or laptop, used by the user 200. The user 200 may then take the accessory 400 that was printed with the biometric design and install the accessory 400 on the electronic device 230. For example, the user 200 may put their smartphone in a smartphone case that was printed with a waveform of the user's voice. The live wallpaper 615 may be set as the wallpaper for the electronic device 230. For example, the live wallpaper 615 may be an image of a waveform of the user's voice, which may be set as the wallpaper for the smartphone animated to reflect the noise level of the environment as determined through a microphone of the smartphone.

The biometric data 141 may then be erased from the storage 140, unless the user opts to keep the biometric data 141 for future use. For example, the user 200 may select to have the biometric data 141 transferred to the electronic device 230, so that the user 200 may use the biometric data 141 for their own purposes.

FIG. 3 shows an example screenshot for biometric case design according to an implementation of the disclosed subject matter. Screen 300 may be a screen for the biometric designer 120, and may be presented to the user 200 on the display 150. The screen 300 may include the biometric design 310, which may be the biometric design generated from the biometric data 141, based on the biometric input received from the user 200. For example, the biometric design 310 may be a particle scatterplot of a sound wave of the voice of the user 200. The design controls 320 may allow the user 200 to select the visual basis for the biometric design 310. For example, the user may select between particle scatterplot, cloud representation, and waveform or crest representation for the biometric design 310.

The screen 300 may also display a rendering 330 of the biometric design 310 on the accessory 400 on which the user 200 will be printing the biometric design 310. The rendering 330 may show the accessory 400, for example, a smartphone case, as it may look with the biometric design 310 printed on it. The view controls 340 may be used to change the view of the accessory 400 depicted in the rendering 330. For example, the user 200 may use the view controls 340 to view the accessory 400 as it may look from the front, back and side. The rendering 330 may or may not also include the electronic device to which the accessory 400 will be attached. For example, a front view rendering 330 may include the accessory 400 with the printed biometric design 310, as well as an image of the screen of the electronic device 230. The rendering 330 showing the screen of the electronic device 230 may also include an image of a live wallpaper 615 on the screen, so that the user 200 may be able to see what the electronic device 230 may look like with the biometric design 310 printed on the accessory 400 and an associated live wallpaper 615 displayed on the screen.

FIG. 4A shows an example biometric case design according to an implementation of the disclosed subject matter. The biometric design 410 may be a waveform representation of speech or sounds from the user 200. For example, the user 200 may speak a phrase into the biometric input device 110, which may be a microphone. The biometric input device 110 may record the sound wave and store it as part of the biometric data 141. The biometric designer 120 may generate the biometric design 410, which may then be printed on an accessory 400, such as a smartphone case, by the printer 210.

FIG. 4B shows an example biometric case design according to an implementation of the disclosed subject matter. The biometric design 420 may be a cloud representation of speech or sounds from the user 200. For example, the user 200 may use the design controls 320 to select the cloud representation for the biometric design, which may result in the biometric design 420.

FIG. 4C shows an example biometric case design according to an implementation of the disclosed subject matter. The biometric design 430 may be a particle scatterplot representation of speech or sounds from the user 200. For example, the user 200 may use the design controls 320 to select the particle scatterplot representation for the biometric design, which may result in the biometric design 430.

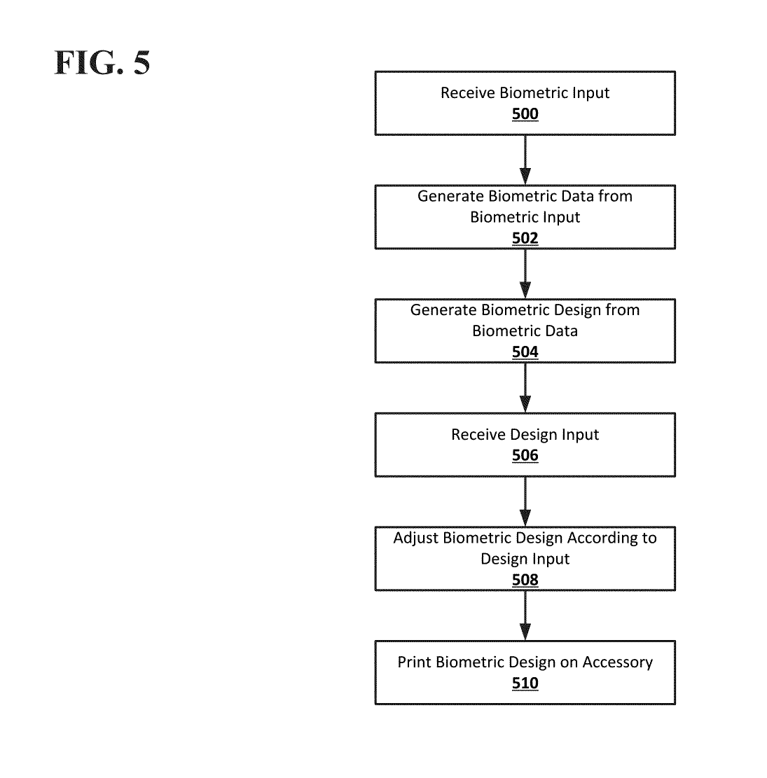

FIG. 5 shows an example of a process for biometric case design according to an implementation of the disclosed subject matter. At 500, biometric input may be received. For example, the biometric input device 110 may receive biometric input, such as a sound wave, a heart-rate, a fingerprint, or any other suitable biometric. The biometric input may be received from, for example, the user 200.

At 502, biometric data 141 may be generated from the biometric input. For example, the biometric input device 110 may store the biometric input as the biometric data 141 in any suitable format, such as sound wave in an audio format for biometric audio input. The biometric input device 110 may also analyze the biometric input and store additional aspects of the biometric input, such as, for example, the frequency, speed, and volume of biometric audio input, in the biometric data 141 with the biometric input.

At 504, a biometric design 310 may be generated from the biometric data 141. For example, the biometric designer 120 may receive the biometric data 141, and may generate a biometric design 310 using any suitable aspects of the biometric data 141. For example, the biometric designer 120 may generate a biometric design 310 that includes a visual representation of a sound wave in the biometric data 141. The biometric design 310 may be generated automatically based on pre-set factors, or the user 200 may be able to select the aspects of the biometric data 141 used to generate the biometric design 310.

At 506, design input may be received. For example, the biometric designer 120 may receive design input from the use 200 through the input device 210. The design input may change aspects of the biometric design 310, such as, for example, visual basis of the biometric design 310, the colors used, or may zoom the biometric design 310 in or out. For example, the user may use the design controls 320 to change the visual basis of the biometric design 310. The user 200 may also use the view controls 340 to change the rendering 330 of the biometric design 310 and accessory 400 on which the biometric design 310 is to be printed.

At 508, the biometric design 310 may be adjusted based on the received design input. For example, the biometric designer 120 may adjust the biometric design 310 based on input to the design controls 320, changing the visual basis for the biometric design 310, or may adjust the colors of the biometric design 310 based on color changes input by the user 200 using the input device 220.

At 510, the biometric design 310 may be printed on an accessory 400. For example, the user 200 may indicate to the biometric designer 120 that they are satisfied with the biometric design 310, for example, based on the rendering 330, and the biometric design 310 should be printed. The biometric design 310 may be sent to the printer 210 to be printed on an accessory 400, such as a smartphone case. The biometric data 141 may be erased from the storage 140 unless the user 200 opts to keep the biometric data 141 for future use.

FIG. 6A shows an example live wallpaper 615 according to an implementation of the disclosed subject matter. The electronic device 600 may include a screen 610. The screen 610 may display a live wallpaper 615 generated by the biometric designer 120. The live wallpaper 615 may an animated visual depiction based on the biometric design 310 printed on the accessory 400 for the electronic device 600. For example, the live wallpaper 615 may be an animated waveform representation of speech or sounds from the user 200. The live wallpaper 615 may change to reflect the noise level in the surrounding environment. For example, the live wallpaper 615 frame 620 may indicate a first noise level.

FIG. 6B shows an example live wallpaper 615 according to an implementation of the disclosed subject matter. The live wallpaper 615 frame 630 may indicate a second noise level that is greater than the first noise level. As the noise level in the surrounding environment changes from the first noise level to the second noise level, the live wallpaper 615 may change from the wallpaper frame 620 to the wallpaper frame 630 to reflect the change. The live wallpaper 615 may include any suitable number of frames of animation in between the live wallpaper 615 frame 620 and the live wallpaper 615 frame 630.

FIG. 6C shows an example live wallpaper 615 according to an implementation of the disclosed subject matter. The live wallpaper 615 frame 640 may indicate a third noise level that is greater than the second noise level. As the noise level in the surrounding environment changes from the second noise level to the third noise level, the live wallpaper 615 may change from the live wallpaper 615 frame 630 to the live wallpaper 615 frame 640 to reflect the change. The live wallpaper 615 may include any suitable number of frames of animation in between the live wallpaper 615 frame 630 and the live wallpaper 615 frame 640.

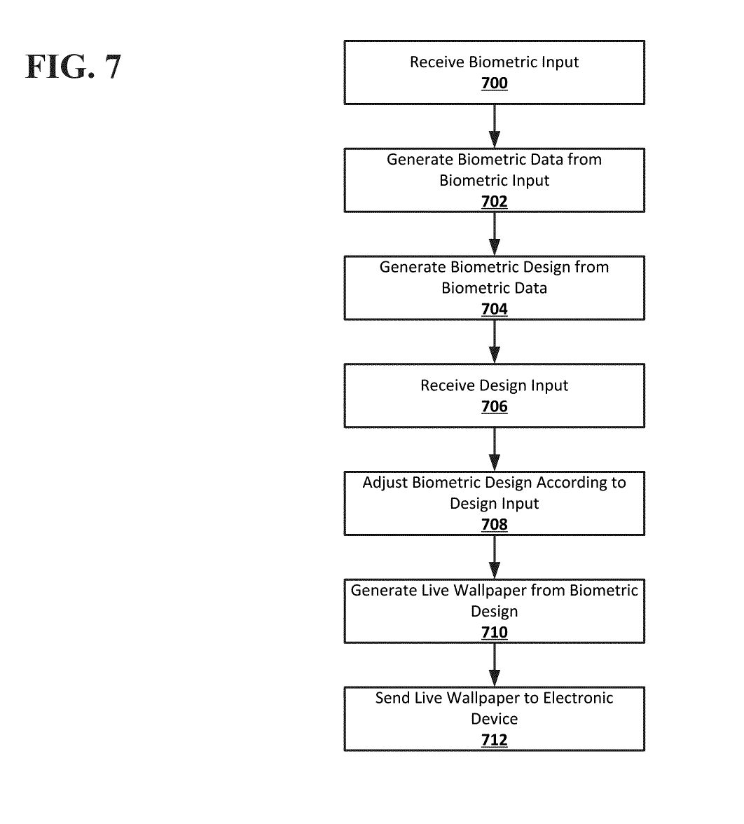

FIG. 7 shows an example of a process for live wallpaper 615 design for a biometric case design according to an implementation of the disclosed subject matter. At 700, biometric input may be received. For example, the biometric input device 110 may receive biometric input, such as a sound wave from speech, a heart-rate, a fingerprint, or any other suitable biometric. The biometric input may be received from, for example, the user 200.

At 702, biometric data 141 may be generated from the biometric input. For example, the biometric input device 110 may store the biometric input as the biometric data 141 in any suitable format, such as sound wave in an audio format for biometric audio input. The biometric input device 110 may also analyze the biometric input and store additional aspects of the biometric input, such as, for example, the frequency, speed, and volume of biometric audio input, in the biometric data 141 with the biometric input.

At 704, a biometric design 310 may be generated from the biometric data 141. For example, the biometric designer 120 may receive the biometric data 141, and may generate a biometric design 310 using any suitable aspects of the biometric data 141. For example, the biometric designer 120 may generate a biometric design 310 that includes a visual representation of a sound wave in the biometric data 141. The biometric design 310 may be generated automatically based on pre-set factors, or the user 200 may be able to select the aspects of the biometric data 141 used to generate the biometric design 310.

At 706, design input may be received. For example, the biometric designer 120 may receive design input from the use 200 through the input device 210. The design input may change aspects of the biometric design 310, such as, for example, visual basis of the biometric design 310, the colors used, or may zoom the biometric design 310 in or out. For example, the user may use the design controls 320 to change the visual basis of the biometric design 310. The user 200 may also use the view controls 340 to change the rendering 330 of the biometric design 310 and accessory 400 on which the biometric design 310 is to be printed.

At 708, the biometric design 310 may be adjusted based on the received design input. For example, the biometric designer 120 may adjust the biometric design 310 based on input to the design controls 320, changing the visual basis for the biometric design 310, or may adjust the colors of the biometric design 310 based on color changes input by the user 200 using the input device 220.

At 710, a live wallpaper 615 may be generated from the biometric design 310. For example, the biometric designer 120 may generate a live wallpaper 615 based on the biometric design 310, such as the biometric design 310. The live wallpaper 615 may be generated to visually complement the biometric design 310. The animation of the live wallpaper 615 may be based on the properties of the biometric input used to generate the biometric design 310. For example, a biometric design 310 based on biometric audio input may be animated based on noise levels. The live wallpaper 615 maybe adjusted, for example, by the user 200, changing the basis for the animation of the live wallpaper 615, the colors of the live wallpaper 615, or other aspects of the design of the live wallpaper 615.

At 712, the live wallpaper 615 may be sent to an electronic device. For example, the biometric designer 120 may send the live wallpaper 615 to the electronic device 230 using any suitable wired or wireless connection. The live wallpaper 615 may be set as the wallpaper for the electronic device 230, where the live wallpaper 615 may be displayed, for example, on the screen 610. The live wallpaper 615 may be animated, and the display of the live wallpaper 615 on the screen 610 may change to match the basis for the animation of the live wallpaper 615, such as, for example, changing noise levels in the surrounding environment.

In situations in which the systems discussed here collect personal information about users, or may make use of personal information, the users may be provided with an opportunity to control whether programs or features collect user information (e.g., the type of biometric information that may or may not be collected, information about a user's social network, social actions or activities, profession, a user's preferences, or a user's current location), or to control whether and/or how to receive content from the content server that may be relevant to the user. In addition, certain data such as biometric data 141 may be treated in one or more ways before it is stored or used, so that personally identifiable information is removed. Thus, the user may have control over how information is collected about the user and used by a system as disclosed herein. The user may also be provided with an opportunity to control how collected biometric information is used. For example, the user may be able to limit the use of such biometric information to the design of accessories 400 and wallpapers.

Embodiments of the presently disclosed subject matter may be implemented in and used with a variety of component and network architectures. FIG. 8 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 9.

Many other devices or components (not shown) may be connected in a similar manner, such as document scanners, digital cameras, auxiliary, supplemental, or backup systems, or the like. Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 9 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
receiving biometric input at a biometric input device of a computing device, wherein the biometric input is generated through user interaction with the biometric input device;
generating biometric data from the biometric input;
generating a biometric design based on the biometric data; and
printing the biometric design on an accessory for an electronic device with a printer co-located with the computing device.

2. The computer-implemented method of claim 1, wherein the biometric data comprises a representation of the biometric input and at least one aspect of the biometric input.

3. The computer-implemented method of claim 2, wherein the biometric design is based on one or more of the representation of the biometric input and at least one aspect of the biometric input.

4. The computer-implemented method of claim 1, wherein the biometric input device comprises a microphone, a camera, a fingerprint scanner, a heart-rate monitor, or a thermometer.

5. The computer-implemented method of claim 1, wherein the biometric input comprises speech or sounds from the user, a scan of a fingerprint of the user, a heart-rate of the user, or a temperature of the user.

6. The computer-implemented method of claim 1, wherein the at least one aspect of the biometric input comprises a frequency, speed, pattern or volume of a sound wave, or a strength, beat, or pattern of a heart-rate.

7. The computer-implemented method of claim 1, wherein the accessory is a smartphone case, a watch band, or a laptop case.

8. The computer-implemented method of claim 1, wherein a visual basis for the biometric design is automatically selected.

9. The computer-implemented method of claim 3, wherein the at least one aspect of the biometric input on which the biometric design is based is automatically selected.

10. The computer-implemented method of claim 1, further comprising:
receiving design input; and
adjusting the biometric design based on the design input.

11. The computer-implemented method of claim 10, wherein the design input comprises a color change or a change to a visual basis for the biometric design.

12. The computer-implemented method of claim 1, further comprising displaying on a display a rendering of the accessory with the biometric design.

13. The computer-implemented method of claim 1, further comprising:
generating a live wallpaper based on the biometric design; and
sending the live wallpaper to the electronic device.

14. The computer-implemented method of claim 13, wherein the live wallpaper comprises an animation visually based on the biometric design.

15. The computer-implemented method of claim 14, wherein the animation of the live wallpaper is based on input to the electronic device.

16. A computer-implemented system for biometric case design comprising:
a computing device adapted to generate a biometric design from biometric data;
a biometric input device connected to the computing device, the biometric input device adapted to receive biometric input from a user and store the biometric input as the biometric data; and
a printer connected to the computing device and adapted to receive a biometric design from the computing device and print the biometric design on an accessory for an electronic device.

17. The computer-implemented system of claim 16, wherein the biometric input device is built-in to the computing device.

18. The computer-implemented system of claim 16, wherein the computing device is further adapted to receive design input from an input device and adjust the biometric design based on the design input.

19. The computer-implemented system of claim 16, wherein the computing device is further adapted to generate a live wallpaper based on the biometric design and send the live wallpaper to the electronic device.

20. The computer-implemented system of claim 16, wherein the biometric input device is further adapted to analyze the biometric input to generate at least one aspect of the biometric input and to store the at least one aspect of the biometric input with the biometric data.

21. A system comprising: one or more computers and one or more storage devices storing instructions which are operable, when executed by the one or more computers, to cause the one or more computers to perform operations comprising:
receiving biometric input at a biometric input device of a computing device, wherein the biometric input is generated through user interaction with the biometric input device;
generating biometric data from the biometric input;
generating a biometric design based on the biometric data; and
printing the biometric design on an accessory for an electronic device with a printer co-located with the computing device.

22. The system of claim 21, wherein the instructions further cause the one or more computers to perform operations comprising:
generating a live wallpaper based on the biometric design; and
sending the live wallpaper to the electronic device.
